(19) United States
(12) Patent Application Publication
(10) Pub. No.: US 2002/0017852 A1
(43) Pub. Date: Feb. 14, 2002

(54) Color cathode ray tube

(76) Inventors: Tomoki Nakamura, Mobara (JP); Hirotsugu Sakamoto, Chiba (JP); Shinichi Kato, Mobara (JP)

Correspondence Address: Christopher E. Chalsen, Esq., Milbank, Tweed, Hadley & McCloy LLP, 1 Chase Manhattan Plaza, New York, NY, 10005-1413, US

(21) Appl. No.: 09/829,592

(22) Filed: Apr. 10, 2001

(30) Foreign Application Priority Data
Aug. 3, 2000 (JP) 2000-235650

(51) Int. Cl. H01J 29/50

(52) U.S. Cl. 313/414

(57) ABSTRACT

It is intended to improve the focus characteristic while not requiring an increased focus voltage and hence enabling use of a general-purpose flyback transformer. A focus electrode for formation of a final-stage main lens that focuses electron beams generated by a beam generating section of an electron gun onto a phosphor screen is divided into a plurality of electrode members. The divisional electrode members form plural stages of electron lenses whose focusing power varies in synchronism with the deflection amount of the electron beams. A relationship

31≦L≦4.7V−9.3≦43

is established, where V (mm) is the vertical diameter of an aperture formed in an end portion of the focus electrode that is opposed to an anode electrode and L is the total length (mm) of the focus electrode in the tube axial direction.

The present invention relates to a cathode ray tube (CRT). In particular, the invention relates to a color CRT having an electron gun that exhibits good focus performance over a wide area of a phosphor screen without the need for setting high a focus voltage for controlling the correction of the curvature of field and the correction of astigmatism that is caused by deflection of electron beams.

### BACKGROUND OF THE INVENTION

Color CRTs such as TV picture tubes and display tubes including monitor tubes for information terminals form a prescribed image by scanning, in two directions (vertically and horizontally), a phosphor screen (hereinafter also referred to simply as “screen”) where phosphors are formed with electron beams that are emitted from an electron gun.

To obtain good focus performance over the entire area of the phosphor screen, electron guns used in color CRTs of the above kind are required to control the shapes of beam spots that are formed when emitted electron beams land the phosphor screen in accordance with their deflection angle.

In recent years, monitors and TV receivers have been put into practical use that incorporate a flat tube whose panel outside surface is flat (flat panel color CRT). In particular, in large-screen flat tubes having an effective diagonal size of 51 cm, for example, large differences in focus performance exist between the screen center and peripheral portions.

One known measure for reducing such differences in focus performance is as follows. A focusing electrode of an electron gun is divided into a plurality of electrode members, and an electrostatic four-pole lens and a curvature-of-field correction lens are formed between those electrode members. A constant focus voltage and another focus voltage obtained by superimposing a dynamic voltage that varies in synchronism with the deflection amount on a constant voltage are applied to those electrode members. Deteriorations in focus performance at screen peripheral portions that increase with the deflection angle are reduced in this manner.

An electron gun of the above kind is formed by arranging, in the tube axial direction, a beam generating section (triode section) that generates a plurality of electron beams and consists of a cathode (usually denoted by K), a control electrode (usually denoted by G1), and an acceleration electrode (usually denoted by G2) and a main lens section that focuses the electron beams generated by the beam generating section (triode section) at the phosphor screen and consists of focus electrodes (usually denoted by G3, G4, and G5) and an anode electrode (usually denoted by G6).

FIG. 9 shows focus voltages that are applied to the focus electrode that is divided into a plurality of electrode members. FIG. 10 shows output voltages of a flyback transformer that generates the focus voltages.

As shown in FIG. 9, a composite lens electron gun is formed by dividing the focus electrode G5 of the electron gun into multiple stages (in this example, three stages of electrode members A, B, and C). An electrostatic four-pole lens and a curvature-of-field correction lens are formed by the electrode members A, B, and C.

The electrostatic four-pole lens controls the sectional shape of electron beams that pass through the electrostatic four-pole lens, and thereby reduces the sizes of beam spots formed on the phosphor screen and make their shapes closer to circles.

A first constant voltage Vf1 is applied to the electrode member B. Another focus voltage (Vf2+dVf) obtained by superimposing a dynamic voltage dVf that varies in synchronism with the deflection amount on a second constant voltage Vf2 is applied to the electrode members A and C.

The focus voltages Vf1 and Vf2+dVf are generated by the flyback transformer FBT shown in FIG. 10. Symbol Eb represents an anode voltage (highest voltage) that is applied to the anode electrode G6 and symbol Ec2 represents a pre-focus voltage of about 600 V that is applied to other electrodes (G2 and G4) of the electron gun.

FIG. 11 shows waveforms of focus voltages that are applied to the divisional electrode members of the focus electrode. In FIG. 11, 1V means one vertical deflection period (one frame period or one field period) and 1H means one horizontal deflection period.

When the dynamic voltage dVf is large, that is, when the electron beam deflection amount is large (the electron beams are deflected to screen peripheral portions), the voltage difference in the curvature-of-field correction lens is small and hence the lens power is low. Therefore, when the electron beams are deflected, the electron beam focusing power is weakened and the curvature of field is corrected.

The related art techniques of this kind are disclosed in Japanese Patent Laid-Open Nos. 43532/1992 and 161309/1995.

In particular, in the related art technique disclosed in Japanese Patent Laid-Open No. 43532/1992, the focus electrode adjacent to the anode electrode is divided into a plurality of first electrode members and a plurality of second electrode members and the first electrode members and the second electrode members are arranged alternately. So that electron lenses whose power varies in synchronism with the beam deflection are formed between the first electrode members and the second electrode members, curvature-of-field correction lenses are formed in such a manner that the first electrode members and the second electrode members are independent of each other electrically.

Further, an axially asymmetric electron lens for astigmatism correction that deforms the sectional shape of each electron beam by using the varying dynamic voltage dVf is formed adjacent to the main lens, so that an image that is good over the entire screen can be obtained even if the variation range of the dynamic focus voltage dVf is small.

### SUMMARY OF THE INVENTION

However, in electron guns having a multi-stage focus electrode, the total length is long and hence it is necessary to increase the focus voltage though the beam spot diameters on the screen are reduced. For example, in a flat color CRT having a screen diagonal size of 51 cm and a deflection angle of 90°, the focus voltage increases by about 0.36% when the length of the focus electrode increases by 1 mm.

The focus electrode is generated by a flyback transformer. Usually, the rated output voltage range of flyback transformers used as a power source of CRTs of the above kind is about 28%±2% of the anode voltage. If the focus electrode is elongated and the focus voltage is thereby increased, general-purpose flyback transformers cannot be used. Therefore, decreasing the focus voltage is a subject to be accomplished.

A typical object of the present invention is therefore to provide a color CRT having an electron gun that improves the focus characteristic and that does not require an increased focus voltage and hence enables use of a general-purpose flyback transformer.

According to a representative aspect of the invention, a focus electrode and an anode electrode that form a final-stage main lens for focusing electron beams generated by a beam generating section of the electron gun onto a phosphor screen are arranged in the tube axial direction. The focus electrode is divided into a plurality of electrode members that form plural stages of electron lenses whose focusing power varies in synchronism with the deflection amount of the electron beams. The focus electrode satisfies a relationship:

31≦L≦4.7V−9.3≦43

wherein V (mm) is the vertical diameter of an aperture formed in an end portion of the focus electrode that is opposed to the anode electrode and L (mm) is the total length of the focus electrode in the tube axial direction.

The focus electrode may be formed by at least three electrode members that basically form a composite electron lens.

The focus electrode may be formed by first, second, third, and fourth electrode members that are arranged in this order from the cathode side to the phosphor screen side, and each of an electrostatic four-pole lens and a curvature-of-field correction lens may be formed by opposed ones of the first to fourth electrode members.

The above configurations make it possible to obtain good focus performance in a wide current range and in a wide screen area. Further, since the focus voltage does not increase to a large extent even if the total length of the focus electrode is increased, general-purpose flyback transformers can be used.

The invention is not limited to the above configurations nor the embodiments described below, and various modifications are possible without departing from the spirit and scope of the invention.

### BRIEF DESCRIPTION OF THE DRAWINGS

FIG. 1 is a side view showing the structure of an electron gun used in a color CRT according to an embodiment of the invention;

FIG. 2 is a plan view of a fifth electrode as viewed from line D-D in FIG. 1;

FIG. 3 is a graph showing results of an analysis of the beam spot diameter on the phosphor screen in which the total length of the fifth electrode was varied;

FIG. 4 is a graph showing results of an analysis of a variation of the focus voltage ratio in which the total length of the fifth electrode was varied;

FIG. 5 is a graph showing results of an analysis of a variation of the focus voltage ratio in which the length of the fifth electrode is fixed and the vertical diameter of the fifth electrode is varied;

FIG. 6 is a graph showing results of an analysis of a variation of the beam spot diameter on the phosphor screen in which the vertical diameter of the fifth electrode is varied;

FIG. 7 is a graph showing results of an analysis of the tracking voltage in which the length of the fifth electrode is used as a parameter;

FIG. 8 is a schematic sectional view showing the entire configuration of a color CRT according to the invention;

FIG. 9 shows focus voltages that are applied to a focus electrode that is divided into a plurality of electrode members;

FIG. 10 shows output voltages of a flyback transformer that generates the focus voltages; and

FIG. 11 shows waveforms of focus voltages that are applied to the divisional electrode members of the focus electrode.

### DESCRIPTION OF THE PREFERRED EMBODIMENTS

Embodiments of the present invention will be hereinafter described in detail with reference to the accompanying drawings.

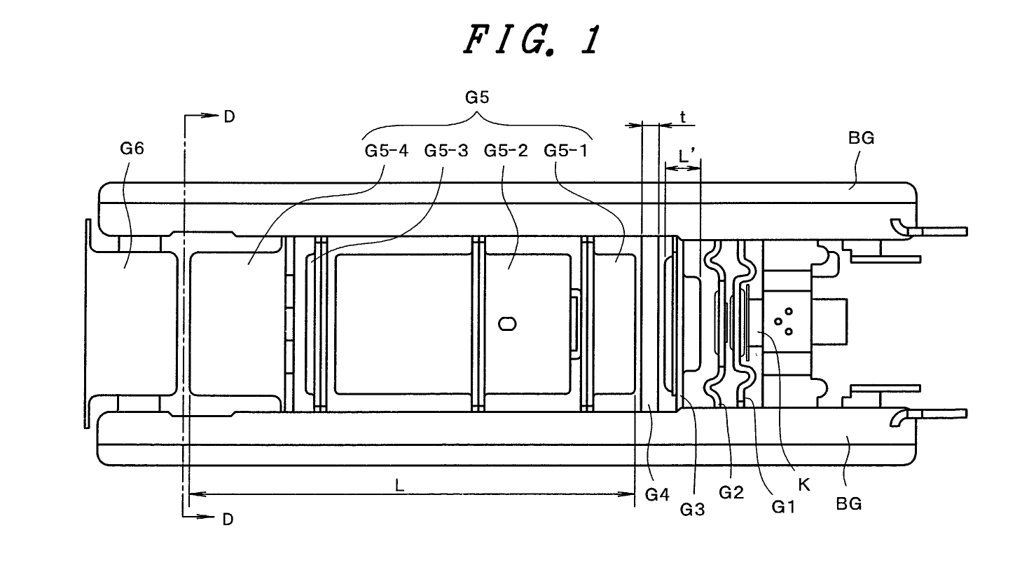

FIG. 1 is a side view showing the structure of an electron gun used in a color CRT according to an embodiment of the invention. This electron gun is composed of an electron beam generating section consisting of a cathode K, a first electrode G1 as a control electrode, and a second electrode G2 as an acceleration electrode, a pre-focus lens consisting of the second electrode G2 and a third electrode G3, a first-stage main lens consisting of the third electrode G3, a fourth electrode G4, and a fifth electrode G5, and a second-stage main lens (final-stage main lens) consisting of the fifth electrode G5 as a final focus electrode and a sixth electrode G6 as an anode.

The above electrodes are partially buried in a pair of beading glasses (multiform Glasses) BG and thereby fixed in a prescribed arrangement. What is called a shield cup (not shown) is attached to the tip of the sixth electrode G6.

The fifth electrode G5 is divided into a first electrode member G5-1, a second electrode member G5-2, a third electrode member G5-3, and a fourth electrode member G5-4. An electrostatic quadruple-pole lens is formed between the first electrode member G5-1 and the second electrode member G5-2 or between the second electrode member G5-2 and the third electrode member G5-3. A curvature-of-field correction lens is formed between the third electrode member G5-3 and the fourth electrode member G5-4. Character L represents the total length of the fifth electrode G5 (in mm).

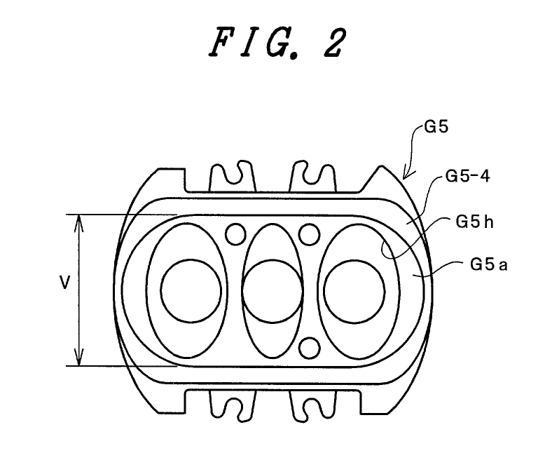

FIG. 2 is a plan view of the fifth electrode G5 as viewed from line D-D in FIG. 1. The fifth electrode G5 has, inside the cylindrical fourth electrode member G5-4, a plate-like internal correction electrode G5a that is formed with three electron beam passage apertures G5h. That is, the internal correction electrode G5a is provided at a position that is deviated toward the cathode K from the end position of the fifth electrode G5 where it is opposed to the sixth electrode G6, and a single aperture which is common in the three electron beams is formed at the end position of the fifth electrode G5 where it is opposed to the sixth electrode G6. The vertical diameter of the single aperture (opposed to the sixth electrode G6) of the cup-shaped fourth electrode member G5-4 that forms the final-stage main lens with the sixth electrode G6 is represented by V (mm).

In this embodiment, the vertical diameter V (mm) of the single aperture (opposed to the sixth electrode G6) of the cup-shaped fourth electrode member G5-4 and the total length L (mm) of the fifth electrode G5 in the tube axial direction have the following relationship:

31≦L≦4.7V−9.3≦43

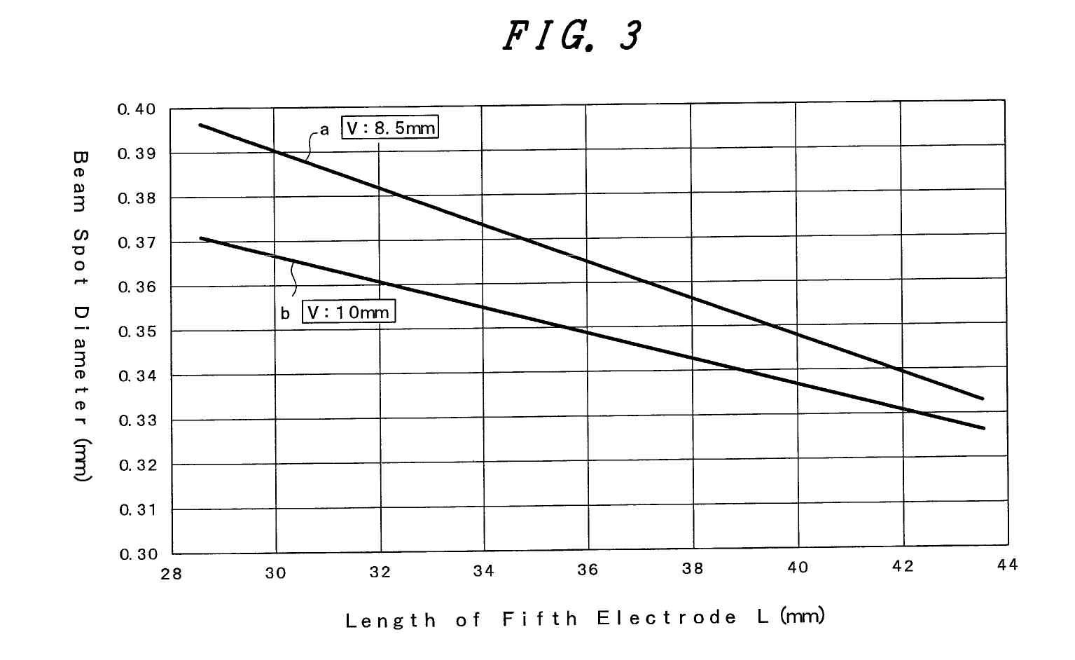

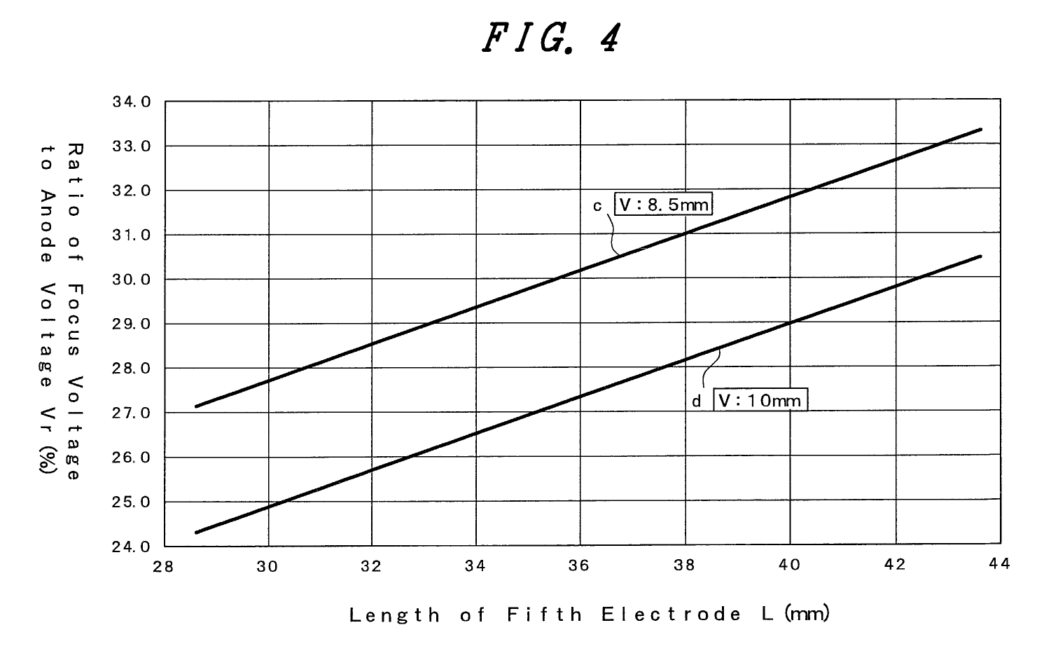

FIG. 3 is a graph showing results of an analysis of the beam spot diameter on the phosphor screen in which the total length L of the fifth electrode G5 was varied. FIG. 4 is a graph showing results of an analysis of a variation of the ratio Vr of the focus voltage to the anode voltage in which the total length L of the fifth electrode G5 was varied.

The analysis conditions were as follows. In a flat color CRT having an effective screen diagonal size of 51 cm and a maximum deflection angle of 90°, the length L′ of the third electrode G3 was 2.5 mm, the length (thickness) of the fourth electrode G4 was 0.5 mm, the anode voltage Eb was 27.5 kV, the voltage applied to the second electrode G2 and the fourth electrode G4 was 600 V, the cathode current lk was 0.3 mA, and the cutoff voltage of the cathode K was 110 V.

In FIG. 3, character a denotes a variation of the beam spot diameter on the phosphor screen with respect to the fifth electrode length L in a color CRT using an electron gun in which the final-stage main lens diameter V is equal to 8.5 mm. Character b denotes a variation of the beam spot diameter on the phosphor screen with respect to the fifth electrode length L in a color CRT using an electron gun in which the final-stage main lens diameter V is equal to 10 mm.

As shown in FIG. 3, the beam spot diameter decreases as the length L of the fifth electrode G5 increases. However, at the same time, as shown in FIG. 4, the ratio Vr of the focus voltage to the anode voltage increases. Where the electron gun whose main lens diameter V is 8.5 mm is used, when the length L of the fifth electrode G5 is increased by 1 mm, the spot diameter decreases by 0.0044 mm (1.1% in terms of the variation ratio) and the focus voltage Vf increases by 100 V (0.364% in terms of the ratio Vr of the focus voltage to the anode voltage).

The focus voltage is generated by a flyback transformer. In general-purpose flyback transformers, the focus voltage range is set at 28%±2% of the anode voltage. Therefore, general-purpose flyback transformers cannot accommodate the above increase of the focus voltage. Therefore, it is necessary to decrease the focus voltage.

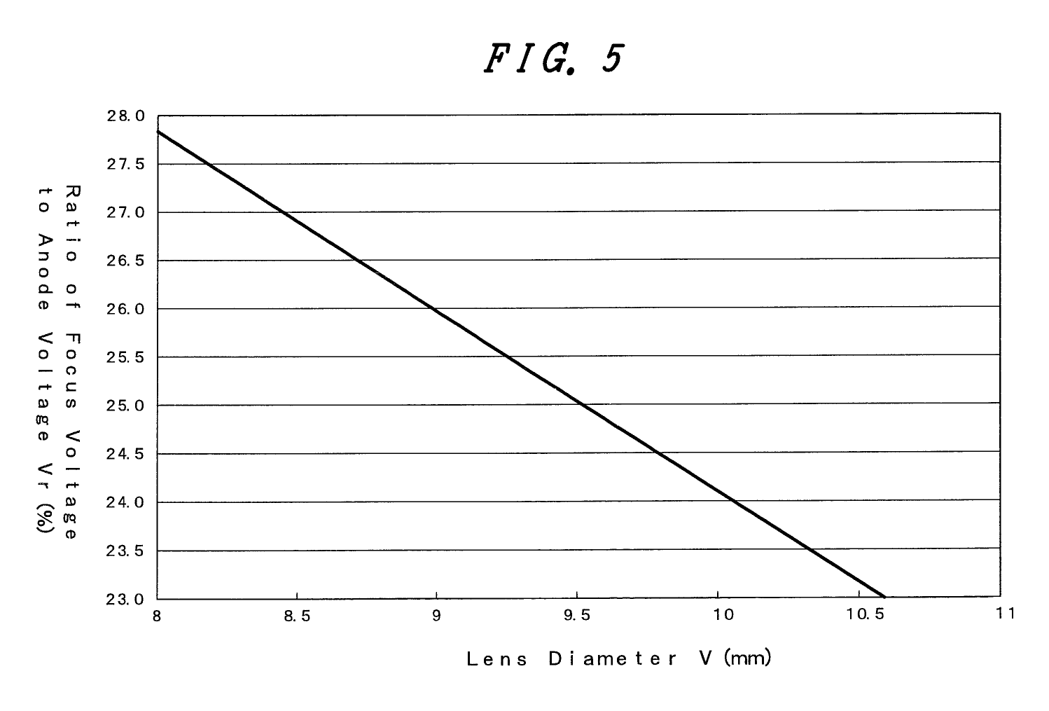

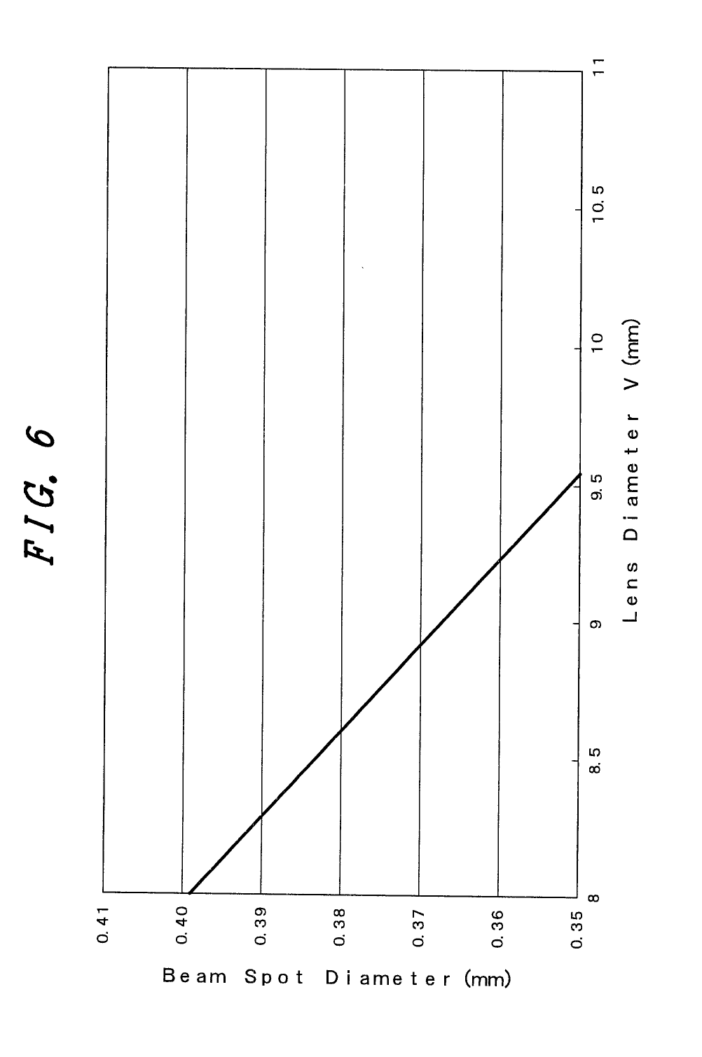

FIG. 5 is a graph showing results of an analysis of a variation of the ratio Vr of the focus voltage to the anode voltage in which the length L of the fifth electrode G5 is fixed and the vertical diameter V of the fifth electrode G5 on the side where the final-stage main lens is formed is varied. FIG. 6 is a graph showing results of an analysis of a variation of the beam spot diameter on the phosphor screen in which the vertical diameter V of the fifth electrode G5 on the side where the final-stage main lens is formed is varied.

As shown in FIG. 5, when the vertical diameter V of the fifth electrode G5 on the final-stage main lens formation side is increased by 1 mm, the focus voltage Vf can be decreased by 500 V (1.82% in terms of the ratio Vr of the focus voltage to the anode voltage). As shown in FIG. 6, when the vertical diameter V of the fifth electrode G5 on the final-stage main lens formation side is increased by 1 mm, the beam spot diameter decreases by 0.017 mm (4% in terms of the variation ratio).

It is concluded from the relationships of FIGS. 4 and 5 that a large-diameter main lens that is improved in focus performance can be realized in the unipotential-bipotential electron gun without increasing the focus voltage by forming the main lens so that a relationship:

L≦4.7V−9.3 (1)

is satisfied, where L (mm) is the length of the fifth electrode and V (mm) is the vertical diameter of the fifth electrode G5 on the final-stage main lens formation side. Inequality (1) is derived on the following grounds.

In FIG. 4, the slope of the straight line c (the straight line d has the same slope as the straight line c because they are parallel with each other) is such that as the length L of the fifth electrode G5 increases from 33 mm to 38 mm, for example, the ratio Vr of the focus voltage to the anode voltage increases from 29% to 31%. This relationship be expressed by the following equation:

Vr={(31−29)/(38−33)}×L+C1=0.4L+C1

wherein C1 is a constant that is determined from the graph.

In FIG. 5, as the vertical diameter V of the fifth electrode G5 on the final-stage main lens formation side increases from 8.5 mm to 10 mm, the focus voltage ratio Vr decreases from 26.9% to 24.1%. This relationship is expressed by the following equation:

Vr=−{(26.9−24.1)/(10−8.5)}×V+C2=−1.87V+C2

wherein C2 is a constant that is determined from the graph.

As described above, the ratio Vr of the focus voltage to the anode voltage is proportional to the total length L of the fifth electrode G5 and is also proportional (the slope is negative) to the vertical diameter V of the fifth electrode G5 on the final-stage main lens formation side. The focus voltage ratio Vr is expressed by the following equation as a function of the length L of the fifth electrode G5 and the vertical diameter V of the fifth electrode G5 on the final-stage main lens formation side:

Vr=0.4L−1.87V+C

The constant C can be determined by using measured values of Vr, L, and V.

For example, in the case of the straight line d in FIG. 4, when the vertical diameter V of the fifth electrode G5 on the final-stage main lens formation side is 10 mm and the length L of the fifth electrode G5 is 40 mm, the ratio Vr of the focus voltage to the anode voltage is 29%. By substituting these values into the above equation, the constant C is determined as 31.7. That is, the above equation becomes as follows:

Vr=0.4L−1.87V+31.7

For the ratio Vr of the focus voltage to the anode voltage to conform to the rated output voltage range of general-purpose flyback transformers, the following inequality is established (for Vr to be smaller than or equal to 28%):

28≧0.4L−1.87V+31.7

The above-mentioned inequality (1) is obtained by rearranging this inequality. The numerical values in inequality (1) are ones obtained through rounding.

Further, for the ratio Vr of the focus voltage to the anode voltage to conform to the rated maximum output voltage of general-purpose flyback transformers (Vr should be smaller than or equal to 30%), the following inequality should be satisfied:

30≧0.4L−1.87V+31.7

Rearranging this inequality, we obtain

L≦4.7V−4.3 (1A)

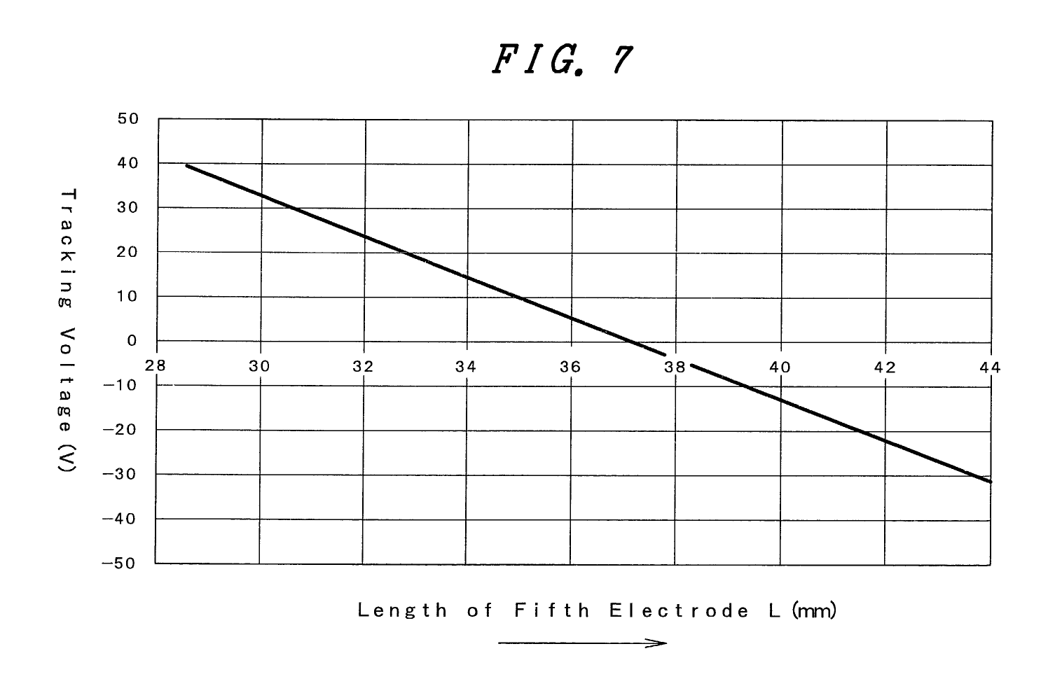

FIG. 7 is a graph showing results of an analysis of the tracking voltage in which the length L of the fifth electrode G5 is used as a parameter. The term “tracking voltage” as used herein means a voltage obtained by subtracting a just-focus voltage when the cathode current lk=0.5 mA from a just-focus voltage when the cathode current lk=0.1 mA. The tracking voltage does not depend on the vertical diameter V of the fifth electrode G5 on the final-stage main lens formation side. When the tracking voltage is closer to 0 V, the focus voltage variation with respect to the cathode current is smaller and hence good focus performance can be obtained in a wider current range.

It is seen from FIG. 7 that the tracking voltage approximately falls within a range of ±30 V and good focus performance is obtained in a wide current range if a relationship

31≦L≦43 (2)

is satisfied.

The tracking voltage range of ±30 V in a range where the focus performance of an image is allowable when the screen brightness of a CRT is lowered from a high brightness value to a low brightness value. That is, when the cathode current is lowered from a large current value to a small current value, the clearness of an image is maintained if the tracking voltage is within ±30 V.

From inequalities (1) and (2), a relationship

8.6≦V≦11.1 (3)

is obtained.

The above descriptions relating to the vertical diameter V are similarly applicable to the sixth electrode (anode electrode) G6 that forms the final-stage main lens with the fifth electrode G5.

In electron guns to be used in actual products, it is most appropriate that the vertical diameter V of the final-stage main lens electrode be 10 mm and the length L of the fifth electrode G5 be 33-33.5 mm.

By using an electron gun that is formed according to the embodiment, a flat panel color CRT having an effective screen diagonal size of 51 cm can be realized for use in a TV receiver or a monitor that uses a general-purpose flyback transformer. That is, the focus characteristic of a CRT can be improved without the need for newly designing a focus circuit, that is, in a state that the electrical compatibility is maintained, in an existing TV set or display terminal.

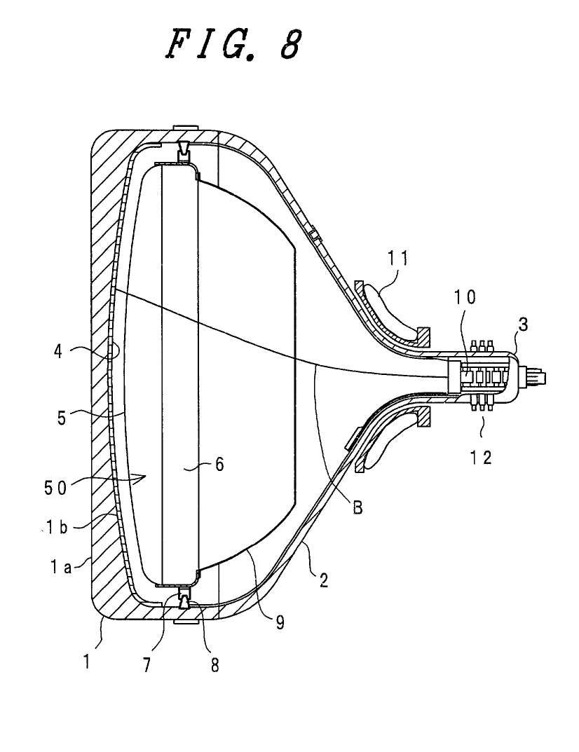

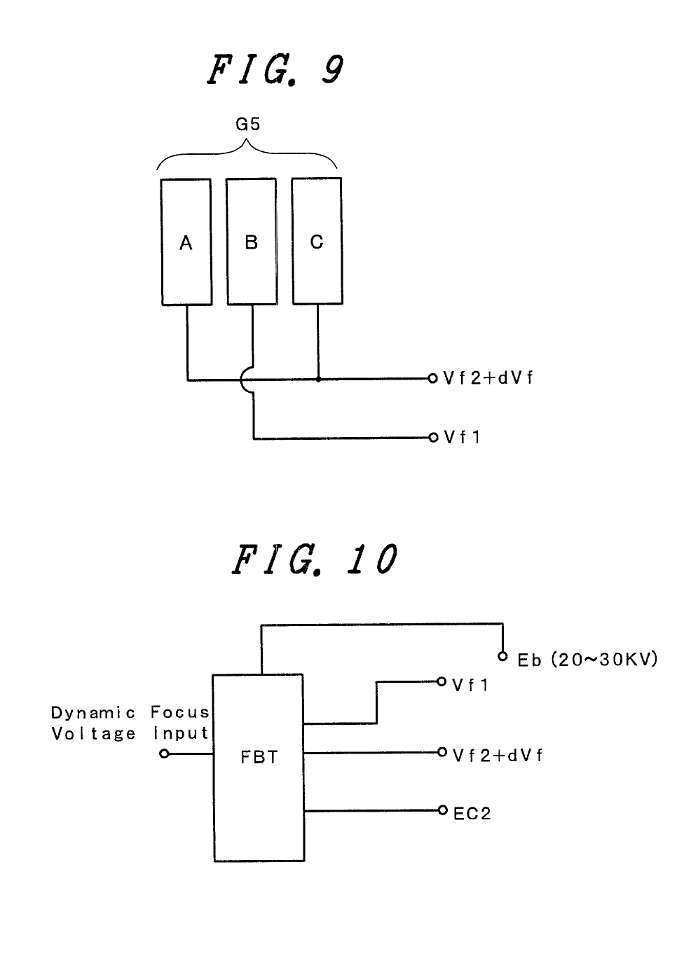

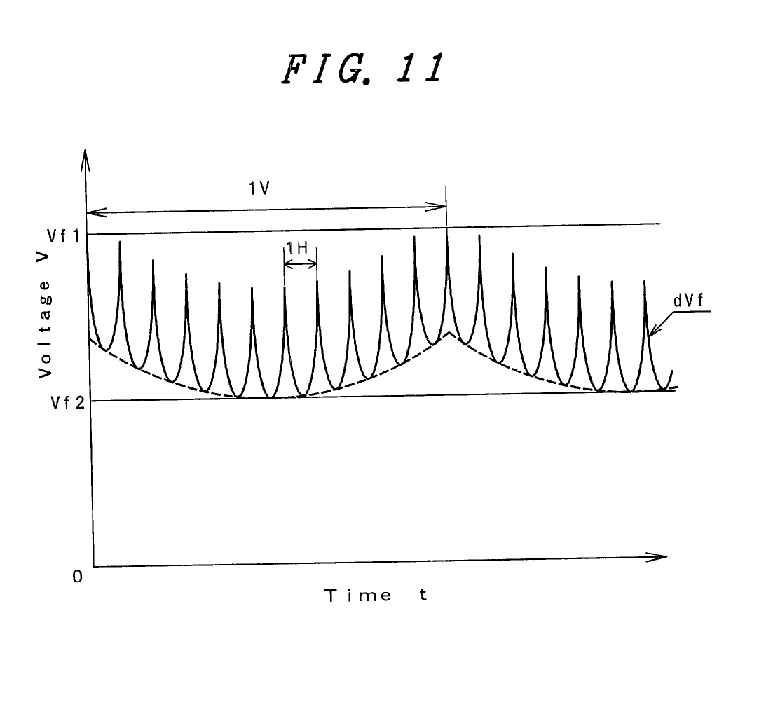

FIG. 8 is a schematic sectional view showing the entire configuration of a color CRT according to the invention. This color CRT is a flat panel color CRT in which the equivalent radius of curvature of an outside surface 1a of a panel 1 is much larger than that of an inside surface 1b. The average radii of curvature of the outside surface 1a of the panel 1 along the major axis, minor axis, and diagonal axes in the effective screen area are greater than 10,000 mm and hence the outside surface 1a looks almost flat. On the other hand, the average radii of curvature of the inside surface 1b of the panel 1 along the major axis, minor axis, and diagonal axes in the effective screen area are smaller than 6,000 mm and hence the inside surface 1b is curved to a much larger extent than the outside surface 1a. This is to employ a press-type shadow mask 5 that can be manufactured easily at a low cost. Like the inside surface 1b of the panel 1, the press-type shadow mask 5 is curved to a large extent along the major axis, minor axis, and diagonal axes in the hole formation area.

A screen 4 is formed on the inside surface 1b of the panel 1 by applying phosphors to it. A shadow mask assembly 50 is disposed close to the phosphor screen 4. For example, the shadow mask assembly 50 is formed by welding, to a mask frame 6 that is 1.1-mm thick and made of iron-type metal, the shadow mask 5 formed by pressing a 0.13-mm Invar sheet. Suspension mechanisms 7 each having a spring member are attached to the side surface of the mask frame 6. The shadow mask assembly 50 is suspended at a prescribed position by engaging the suspension mechanisms 7 with stud pins 8 that are partially buried in the inside wall of the panel 1.

The panel 1 is bonded to the large-diameter opening portion of a funnel 2 and the small-diameter side of the funnel 2 is continuous with a neck 3. An electron gun 10 for emitting three electron beams B are accommodated in the neck 3. The electron gun 10 is the one described in the above embodiment.

External magnetic devices 12 for purity correction etc. are provided around the neck 3. A deflection yoke 11, which is mounted around the transition portion between the funnel 2 and the neck 3 (the neck-side portion of the funnel 2), deflects the three electron beams B in two directions (vertically and horizontally), whereby a two-dimensional image is reproduced on the screen 4. A magnetic shield 9 for shielding the electron beams B from external magnetism such as terrestrial magnetism is fixed to the mask frame 6 on the neck side.

The above color CRT enables high-resolution image display on a large screen having an effective diagonal size of 51 cm, for example.

As described above, the invention makes it possible to provide a color CRT having an electron gun that improves the focus characteristic and that does not require an increased focus voltage and hence enables use of a general-purpose flyback transformer.

What is claimed is:

1. A color CRT comprising:
an electron gun for emitting a plurality of electron beams that are arranged horizontally, the electron gun comprising:
a beam generating section having a cathode, a control electrode, and an acceleration electrode, for generating the electron beams; and
a focus electrode and an anode electrode that form a final-stage main focus lens for focusing the electron beams generated by the beam generating section onto a phosphor screen, the beam generating section, the focus electrode, and the anode electrode being arranged in a tube axial direction, the focus electrode having a plurality of electrode members for forming plural stages of electron lenses having focusing power that varies in synchronism with deflection of the electron beams, the focus electrode satisfying a relationship:
31≦L≦4.7V−9.3≦43
wherein V is a vertical diameter in mm of an aperture formed in an end portion of the focus electrode that is opposed to the anode electrode and L is a total length in mm of the focus electrode in the tube axial direction;
a vacuum envelope formed by a panel having the phosphor screen on an inside surface thereof, a neck that accommodates the electron gun, and a funnel that connects the panel and the neck; and
a deflection device provided outside a neck-side portion of the funnel, for deflecting the electron beam vertically and horizontally.

2. The color CRT according to claim 1, wherein the focus electrode is formed by at least three electrode members.

3. The color CRT according to claim 2, wherein the focus electrode is formed by first, second, third, and fourth electrode members that are arranged in this order from a cathode side to a phosphor screen side, and wherein an electron lens or lenses having focusing power that varies in synchronism with deflection of the electron beams are each formed by opposed ones of the first to fourth electrode members.

4. The color CRT according to claim 3, wherein the electron lenses having focusing power that varies in synchronism with deflection of the electron beams are an electrostatic quadruple-pole lens and a curvature-of-field correction lens.

5. The color CRT according to claim 3, wherein the fourth electrode member is opposed to the anode electrode.

6. The color CRT according to claim 3, wherein the fourth electrode member is cup-shaped electrode.

7. The color CRT according to claim 6, wherein a plate-like electrode having a plurality of electron beam passage apertures is provided inside the fourth electrode member.

8. The color CRT according to claim 2, wherein among the at least three electrode members the electrode member closest to the phosphor screen is opposed to the anode electrode.

9. The color CRT according to claim 8, wherein a plate-like electrode having a plurality of electron beam passage apertures is provided inside the electrode member closest to the phosphor screen at a position deviated toward the cathode from an end position of which the electrode member closest to the screen is opposed to the anode electrode.

10. The color CRT according to claim 1, wherein the aperture formed in the end portion of the focus electrode that is opposed to the anode electrode is a single aperture that is common to the electron beams.

11. A color CRT comprising:
an electron gun for emitting three electron beams that are arranged horizontally, the electron gun comprising:
a beam generating section having a cathode, a control electrode, and an acceleration electrode, for generating the three electron beams; and
a focus electrode and an anode electrode that form a final-stage main focus lens for focusing the three electron beams generated by the beam generating section onto a phosphor screen, the beam generating section, the focus electrode, and the anode electrode being arranged in a tube axial direction, the focus electrode being divided into a plurality of electrode members, the focus electrode satisfying relationships
31≦L≦43, and
8.6≦V≦11.1
wherein V is a vertical diameter in mm of an aperture formed in an end portion of the focus electrode that is opposed to the anode electrode and L is a total length in mm of the focus electrode in the tube axial direction; and
a vacuum envelope formed by a panel having the phosphor screen on an inside surface thereof, a neck that accommodates the electron gun, and a funnel that connects the panel and the neck.

12. The color CRT according to claim 11, wherein the focus electrode is divided into at least three electrode members.

13. The color CRT according to claim 12, wherein among the at least three electrode members the electrode member closest to the phosphor screen is opposed to the anode electrode.

14. The color CRT according to claim 13, wherein a plate-like electrode having three electron beam passage apertures is provided inside the electrode member closest to the phosphor screen at a position deviated toward the cathode from an end position of which the electrode member closest to the phosphor screen is opposed to the anode electrode.

15. The color CRT according to claim 13, wherein a single aperture common to the three electron beams is formed in an end portion of the electrode member closest to the phosphor screen that is opposed to the anode electrode.

16. The color CRT according to claim 12, wherein the at least three electrode members form plural stages of electron lenses having focusing power that varies in synchronism with deflection of the three electron beams.

17. The color CRT according to claim 16, wherein one of the electron lenses having focusing power that varies in synchronism with deflection of the three electron beams is an electrostatic quadruple-pole lens.

18. The color CRT according to claim 17, wherein another one of the electron lenses having focusing power that varies in synchronism with deflection of the three electron beams is a curvature-of-field correction lens.

19. The color CRT according to claim 11, wherein the anode electrode satisfies a relationship:
8.6≦V′≦11.1
wherein V′ is a vertical diameter in mm of an aperture formed in an end portion of the anode electrode that is opposed to the focus electrode.

20. The color CRT according to claim 19, wherein a single aperture common to the three electron beams is formed in an end portion of the anode electrode that is opposed to the focus electrode.
